(19) United States
(12) Patent Application Publication
(10) Pub. No.: US 2015/0177924 A1
(43) Pub. Date: Jun. 25, 2015

(54) IMAGE PROCESSING APPARATUS AND IMAGE PROCESSING METHOD

(71) Applicant: CANON KABUSHIKI KAISHA, Tokyo (JP)

(72) Inventor: Toshiyuki Kuroda, Yokohama-shi (JP)

(21) Appl. No.: 14/556,457

(22) Filed: Dec. 1, 2014

(30) Foreign Application Priority Data
Dec. 19, 2013 (JP) 2013-262864

(51) Int. Cl. G06F 3/0482

(52) U.S. Cl. CPC G06F 3/0482

(57) ABSTRACT

An image processing apparatus is configured to display a thumbnail of an image file including the thumbnail among files to be processed in advance on a screen, and thereafter, the image processing apparatus displays a thumbnail generated from a main image of an image file not including a thumbnail on the screen.

### BACKGROUND OF THE INVENTION

1. Field of the Invention

The present invention relates to an image processing apparatus and an image processing method, and relates to an image processing apparatus and an image processing method for displaying thumbnails of a file.

2. Description of the Related Art

In recent years, a digital camera capable of saving the processed image data as an image file in a storage medium such as a memory card by electronically processing photographed image data has become popular. Atypical method of saving image data includes a method of using an Exif file format capable of saving a main image and a thumbnail being a reduced image of the main image, in the same file. The image data stored in a storage medium are processed through the use of various processing apparatuses such as a digital camera, a PC, and a printer, for the purposes of browsing, editing, and printing. Furthermore, in parallel with the popularization of digital cameras, the increase in the capacity of a storage medium that stores photographed image data is advancing. Therefore, there has been required a displaying method capable of accessing a target set of image data quickly and efficiently from the data stored in a storage medium having a large capacity and displaying the target set of image data. Japanese Patent Laid-Open No. 2005-136495 discloses a displaying method in which, in the case where a large quantity of image data is stored in a storage medium, a display time of each image is always maintained constant in order to increase the efficiency in image confirmation.

In the technique of Japanese Patent Laid-Open No. 2005-136495, all images are tried to be displayed for a prescribed time, and as a result, there may be a case where neither of images can be displayed.

### SUMMARY OF THE INVENTION

An image processing apparatus according to the present invention includes an obtaining unit configured to obtain a thumbnail from a first image file including the thumbnail among a plurality of image files to be processed; a generating unit configured to generate a thumbnail based on image data included in a second image file which does not include a thumbnail among the plurality of image files to be processed; and a display control unit configured to sequentially display, on a display apparatus, a plurality of thumbnails corresponding to the plurality of image files to be processed such that the thumbnail obtained by the obtaining unit is displayed in preference to the thumbnail generated by the generating unit.

According to the present invention, in the case where a plurality of thumbnails corresponding to a plurality of image files is displayed on a display apparatus, an appropriate thumbnail can be displayed in a preferential manner.

Further features of the present invention will become apparent from the following description of exemplary embodiments (with reference to the attached drawings).

### BRIEF DESCRIPTION OF THE DRAWINGS

FIG. 1 is a block diagram showing a configuration example of an image processing apparatus;

FIG. 2 is an illustration showing an example of a functional block of the image processing apparatus;

FIG. 3 is a diagram showing an example of a content stored in a file list storage unit;

FIG. 4 is an illustration showing an example of a position of each of nine images displayed on a display unit;

FIG. 5 is a flowchart showing an example of processing by which nine screens are displayed in the image processing apparatus;

FIG. 6 is an illustration showing an example of an order of displaying nine images on a display unit;

FIG. 7 is an illustration showing an example of a content of each of nine images displayed on the display unit 106;

FIG. 8 is a flowchart showing an example of processing by which the image processing apparatus displays nine screens;

FIG. 9 is a flowchart showing an example of processing by which nine screens are displayed in the image processing apparatus;

FIG. 10 is an illustration showing an example of an order of displaying nine images on the display unit; and

FIG. 11 is an illustration showing an example of a content of each of nine images displayed on the display unit.

### DESCRIPTION OF THE EMBODIMENTS

Hereinafter, with reference to drawings, description will be given exemplarily in detail to preferable embodiments of the present invention. The relative arrangement of constituent elements, display screens and the like described in the embodiments are not intended to limit the scope of the present invention only to them, as long as there is no specific description in particular.

### First Embodiment

Hereafter, description will be given to an image processing apparatus which displays nine images on a single screen as one embodiment of the present invention and allows a user to search a desired image while visually confirming images.

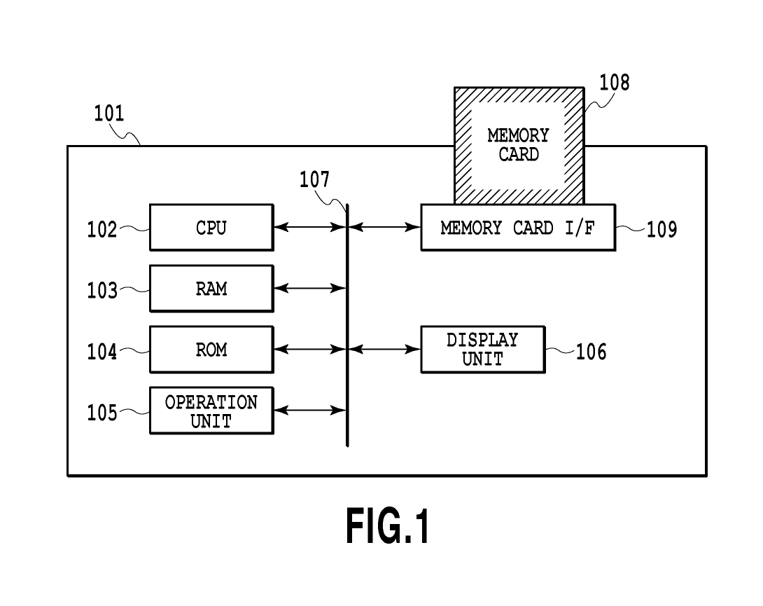

FIG. 1 is a block diagram showing a configuration of an image processing apparatus 101. The image processing apparatus 101 includes a CPU 102, a RAM 103, a ROM 104, an operation unit 105, a display unit 106, and a memory card I/F 109. These components are mutually connected via a bus interface 107. The CPU 102 controls the image processing apparatus 101. The RAM 103 functions as a temporary storage unit. The ROM 104 stores various kinds of setting and programs. The operation unit 105 is constituted by a keyboard, a touch panel, an operation button or the like, and receives input from a user. The display unit 106 is constituted by a liquid crystal display or the like. Furthermore, the display unit 106 may be constituted so as to receive input from a user via a touch panel. The memory card I/F 109 is an interface to input various kinds of data such as image data stored in a memory card 108 into the image processing apparatus 101.

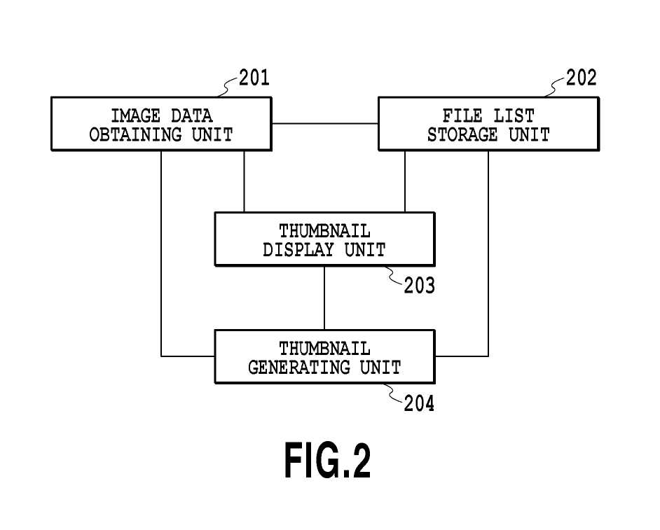

FIG. 2 is an illustration showing an example of a functional block with regard to image processing of the image processing apparatus 101 according to this embodiment. The image processing apparatus 101 according to this embodiment includes an image data obtaining unit 201, a file list storage unit 202, thumbnail display unit 203, and a thumbnail generating unit 204. The programs corresponding to the functional block shown in FIG. 2 are stored as program modules in the ROM 104. The CPU 102 executes these program modules on the RAM 103, whereby the CPU 102 can operate as respective functional blocks shown in FIG. 2.

The image data obtaining unit 201 obtains image data from the memory card 108 via the memory card I/F 109. These image data are data which are prescribed by, for example, an Exif file format, and in which a main image and a thumbnail being a reduced image of the main image are saved in the same file. The main image is used with intention of being distinguished from a thumbnail, and represents generally image data such as JPEG. In the case where the obtained image data do not form a file of the Exif file format, only a main image is saved as an image file. For example, in an image file generated by causing a reading apparatus to read a document, and in an image file generated by a rendering application, a thumbnail may not be included.

Note that the above image data are used as simply one example, and the embodiment of obtaining image data in other various formats may be adopted. Hereafter, the image data will be described as an image file.

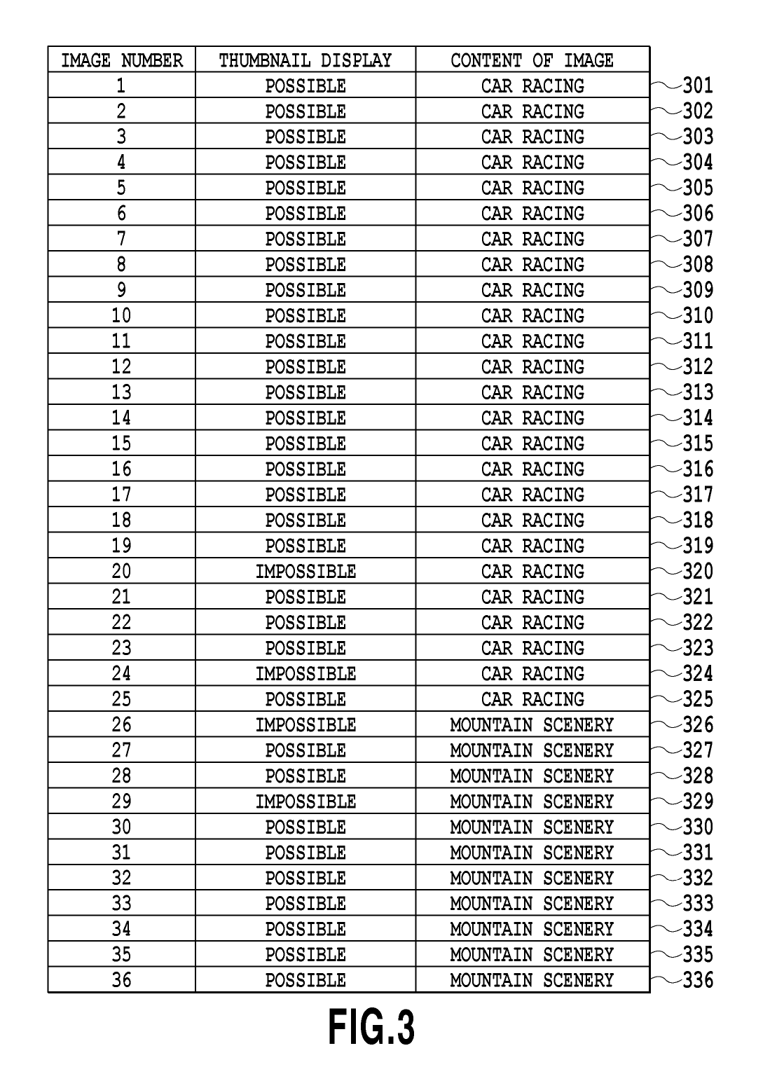

The file list storage unit 202 stores a file list of image files stored in the memory card 108. FIG. 3 is a diagram showing one example of a file list stored in the file list storage unit 202. The file list storage unit 202 searches in the memory card 108 and stores information on an image file as a file list shown in FIG. 3. The file list shown in FIG. 3 includes an image number, information indicating whether or not thumbnail display is possible, and information on the content of an image. It is assumed that each item in the list is associated with information for accessing each image file, such as a file name and an address path of each image file. An example in FIG. 3 shows that image files 301 to 325 include images showing car races, and image files 326 to 336 include images showing mountain scenery.

A thumbnail is not saved in each of image files 320, 324, 326, and 329. Therefore, in the list of FIG. 3, in each of these image files, information indicating that thumbnail display is impossible is described. In this embodiment, in the case where a thumbnail is included in an image file, it is assumed that thumbnail display is possible.

Furthermore, in the case where a thumbnail is not included in an image file, by performing reduction processing on a main image in the image file, it becomes possible to display a reduced image corresponding to a thumbnail. Alternatively, in the case where a thumbnail is included, but also in the case of an image file in which an aspect ratio of a main image is different from that of a thumbnail, reduction processing is also performed on the main image, and the above reduced image may be displayed. In this way, in the case of displaying a reduced image obtained by reducing a main image, since the reduction processing is needed as compared with a case of displaying a thumbnail by reading out the thumbnail from a file, it takes time to the display the reduced image. Therefore, for example, in the case of displaying a plurality of thumbnails sequentially, since the reduction processing for one image file takes time, even if another image file includes a thumbnail, there are cases where the thumbnail may not be displayed.

Then, in this embodiment, in the case of sequentially displaying a plurality of images corresponding to a plurality of image files on a display screen, priority is given to an image file including a thumbnail, as a display target. With this, in the above display, the time until an image is first displayed can be shortened. The detail of the display control processing will be described later.

In the file list of FIG. 3, it is assumed that the image files are sorted from the image file 301 to the image file 336 in an ascending order based on time information (time and date of generation of an image file, or time and date of compilation of an image file). Note that the file list of FIG. 3 is shown only as an example, and a file list to be stored in the file list storage unit 202 is not limited to the example. Typically, a file list may list simply the name of an image file thereon. That is, the file list may be a list which does not include information indicating whether or not thumbnail display is possible, the content of an image and the like, as shown in FIG. 3. Furthermore, the image number in FIG. 3 is merely an identification number sequentially given thereto for convenience of description, and thus the fill name may be used in place of the image number. The file list storage unit 202 suitably updates a list.

In this embodiment, as an example of the display control processing of a plurality of thumbnails, nine images are made to a displayed target in accordance with the time information of each of the image files shown by the file list of FIG. 3. As described above, depending on a generation method for an image file (photographing with a digital camera, reading of documents with a scanner, generation with a rendering application) or the like, a thumbnail may or may not be included in an image file. Therefore, in the case where image files are displayed in accordance with the file list shown in FIG. 3, an image file including a thumbnail and an image file not including a thumbnail may exist together in nine files of a display target. For example, in a file list a plurality of image files each including a thumbnail may be included, and a plurality of image files each not including a thumbnail may be included.

In this embodiment, as described later, processing to determine whether or not thumbnail display is possible is performed. The determination may be performed based on the information included in the stored file list as shown in FIG. 3. Alternatively, whether or not thumbnail display is possible may be determined based on processing to search an image file described in a list to thereby check whether or not a thumbnail is included, or the like.

Now, returning to FIG. 2, the description is continued. The thumbnail display unit 203 displays a thumbnail on a display unit 106. The detailed processing will be described later. The thumbnail generating unit 204 generates a thumbnail from a main image included in an image file. The thumbnail generated by the thumbnail generating unit 204 is temporarily stored in the RAM 103.

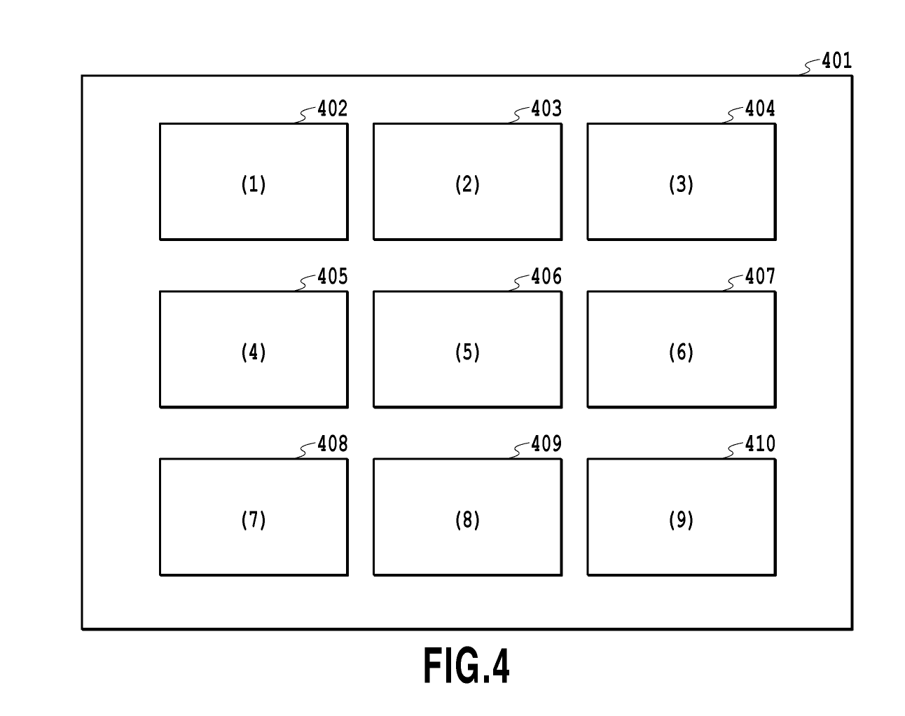

In this embodiment, description will be given to an example in which nine images (thumbnails) are displayed on a single screen as shown in FIG. 4. As described above, since a thumbnail is a reduced image of a main image, in the case where a user checks the content of the main image, the thumbnail display is effective. In this embodiment, in the case where a user finds out a desired image file from among image files included in a memory card, display of a plurality of thumbnails increases the efficiency in file search. At the respective positions from an image position 402 to an image position 410 shown in FIG. 4, the thumbnails are displayed in order from an old image to a new image in accordance with the time information of each of the image files. In this embodiment, an image serving as a reference among images displayed on a single screen is referred to as a reference image. In the example of FIG. 4, it is assumed that a reference image is displayed on the image position 402 serving as the reference in displaying nine images. Note that the image position displaying a reference image is not limited to the image position 402. In the example described below, a reference image is set to the image file 319 in FIG. 3.

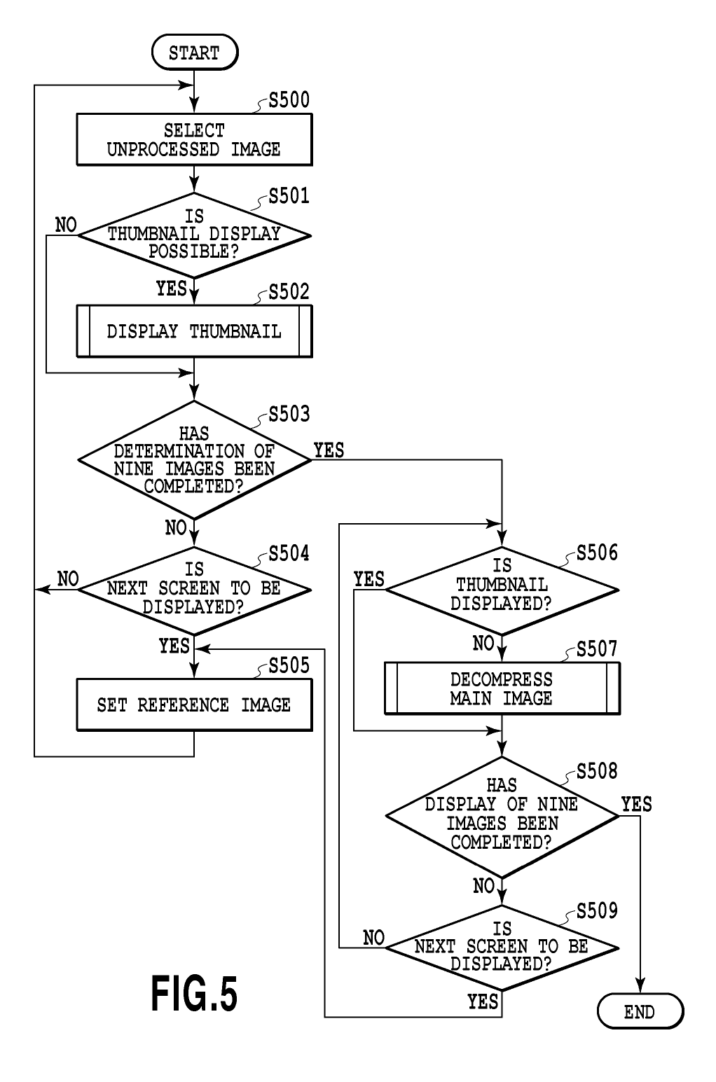

Next, thumbnail display processing of this embodiment will be described. FIG. 5 is a flowchart showing an example of thumbnail display processing of this embodiment. The processing shown in FIG. 5 is realized in such a way that the CPU 102 temporarily reads out a program stored in the ROM 104 to the RAM 103 and executes the program. Furthermore, the processing shown in FIG. 5 is performed by the thumbnail display unit 203 and the thumbnail generating unit 204.

The processing shown in FIG. 5 shows, for example, display processing for a single screen at the time of displaying nine images on the single screen as shown in FIG. 4. The program corresponding to the processing shown in FIG. 5 is stored in the ROM 104, and the CPU 102 executes the program on the RAM 103, whereby the processing shown in FIG. 5 is realized.

In this embodiment, the image file 319 serving as a reference image is made to reference, and nine images (image files 319 to 327) in the list shown in FIG. 3 are caused to be processing targets on a single screen. In Step S500, the CPU 102 operates as the thumbnail display unit 203, and selects unprocessed images among the nine images on the single screen, as images to be processed. Meanwhile, in this selection, the images may be selected in order of the file list shown in FIG. 3, may be selected in reverse order thereof, or may be selected in a random order. In Step S501, the thumbnail display unit 203 determines whether or not thumbnail display of the image to be processed is possible.

In Step S501, in the case where the CPU 102 determines that thumbnail display is possible, the processing is advanced to Step S502. In Step S502, the CPU 102 operates as the thumbnail display unit 203, obtains a thumbnail in the file, and performs thumbnail display control processing to display the thumbnail displayed on a display unit 106. For example, the thumbnail display unit 203 reads out only a thumbnail of an image file from the memory card 108 to an image buffer in the RAM 103 via the memory card I/F 109. Then, the thumbnail display unit 203 analyzes the thumbnail read out to the image buffer in accordance with the program stored in the ROM 104, and displays the thumbnail on the display unit 106. After having displayed the thumbnail in Step S502, the thumbnail display unit 203 advances the processing to Step S503. On the other hand, in the case where it is determined that thumbnail display is not possible in Step S501, the thumbnail display unit 203 advances the processing to Step S503.

In Step S503, the CPU 102 operates as the thumbnail display unit 203, and determines whether or not the determination of the possibility of thumbnail display in Step S501 has been made for all the images of the nine images. In the case where the determination has been completed for all the nine images, the CPU 102 advances the processing to Step S506. On the other hand, in the case where the determination has not been completed for all the nine images, the thumbnail display unit 203 advances the processing to Step S504. In Step S504, the CPU 102 determines whether or not input of a request for displaying the next screen from a user via the operation unit 105 is detected. The request for displaying the next screen means an instruction to display another screen other than the screen to be currently processed, i.e., an instruction to display another nine images. In the case where the operation unit 105 includes a key, for example, the instruction is input by the depression of the key, and in the case where the operation unit 105 includes a touch panel, for example, the instruction is input by a flick operation for the touch panel. Meanwhile, the above request for displaying the next screen may be input by the depression of a key corresponding to a prescribed direction (for example, a right-hand direction), or by a flick operation corresponding to a prescribed direction. In addition, in the case where an operation corresponding to another direction (for example, a left-hand direction), a request for displaying the previous screen may be input.

In the case where such input is not detected, the thumbnail display unit 203 shifts to Step S500, selects the next unprocessed image as an image to be processed, and repeats the processing. On the other hand, in the case where the input of a request for displaying the next screen is detected in Step S504, the thumbnail display unit 203 advances the processing to Step S505. In Step S505, the thumbnail display unit 203 sets up a reference image for displaying the next screen. That is, the thumbnail display unit 203 changes the currently-set reference image from the image file 319 to the image file 328. After having set up a reference image in Step S505, the thumbnail display unit 203 advances the processing to Step S500, and newly performs display of nine images (image files 328 to 336).

Next, description will be given to the process in the case where the determination of the possibility of thumbnail display in Step S501 has been completed for all the images of the nine images in Step S503. In the case where the determination of YES is made in Step S503, it is considered that, among the nine images, a thumbnail has been displayed for each of the images of which thumbnail display is possible. In Step S506, the thumbnail display unit 203 determines whether or not a thumbnail is displayed for one of the nine images. That is, it is determined whether the target image is the image in which a thumbnail has been displayed in Step S502. In the case where the thumbnail display unit 203 has determined in Step S506 that a thumbnail of the target image is displayed, the processing is advanced to Step S508. On the other hand, in the case where the thumbnail display unit 203 has determined in Step S506 that a thumbnail of the target image is not displayed, the processing is advanced to Step S507.

In Step S507, the thumbnail display unit 203 obtains a thumbnail based on a main image included in the image file of an image, of which a thumbnail is not displayed, and displays the thumbnail. Namely, the thumbnail display unit 203 uses the thumbnail generating unit 204 to thereby decompress the main image, and to perform reduction processing on the decompressed main image, thereby generating a thumbnail. In addition, the thumbnail display unit 203 performs image display by using the thumbnail generated by the thumbnail generating unit 204. For example, the thumbnail generating unit 204 reads out a main image included in an image file from the memory card 108 to the image buffer in the RAM 103 via the memory card I/F 109. Then, the thumbnail generating unit 204 decompresses the main image to thereby generate a thumbnail, in accordance with the program stored in the ROM 104. The generated thumbnail is temporarily stored in the image buffer in the RAM 103. The thumbnail display unit 203 displays the thumbnail generated in this way on the display unit 106, in Step S507.

In Step S508, the thumbnail display unit 203 determines whether or not thumbnails of all the nine images have been displayed on the display unit 106. In the case where the display for all the nine images has been completed, the thumbnail display unit 203 ends the processing of the display for the nine images. On the other hand, in the case where the display for the nine images has not been completed, the thumbnail display unit 203 advances the processing to Step S509. In Step S509, the thumbnail display unit 203 determines whether or not input of a request for displaying the next screen from a user via the operation unit 105 is detected. This processing is the same processing as that in Step S504. In the case where the input is not detected, the thumbnail display unit 203 returns to Step S506, and repeats Step S506 through Step S508. In the case where the input of a request for displaying the next screen is detected, the thumbnail display unit 203 advances the processing to Step S505.

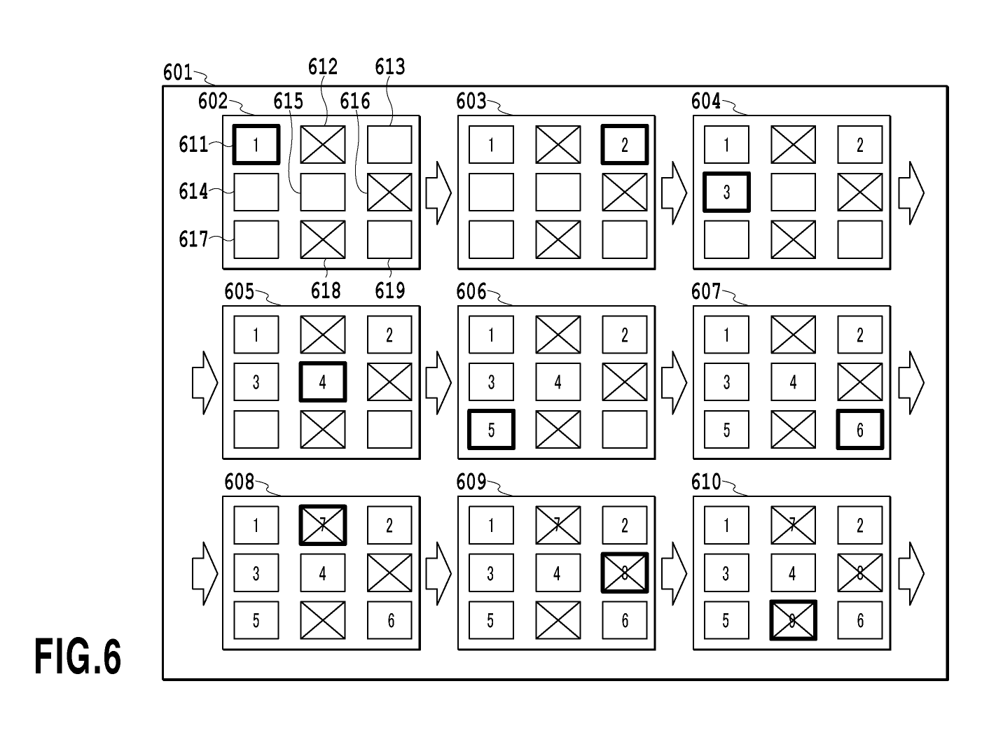

With the above processing, in this embodiment, among the nine image files each to be displayed, an image file including a thumbnail in its file is displayed in preference to an image file not including a thumbnail in its file. For example, in the case of displaying nine images of the image files 319 to 327, the display order thereof is as shown in FIG. 6. FIG. 6 shows that the time series proceed from a screen 602 toward a screen 610. In each of regions 612, 616, and 618 in FIG. 6, a thumbnail is not saved. That is, the regions 612, 616, and 618 are regions at which the image files 320, 324, and 326, of which thumbnail display is made impossible as shown in FIG. 3 are displayed respectively. After having displayed a thumbnail on the region 611 in the screen 602, since the region 612 is a display region for the image 320, of which a thumbnail is not saved, the thumbnail display unit 203 performs thumbnail display on the region 613 without performing thumbnail display on the region 612. This result represents the screen 603. Hereafter, the processing is continued, and the thumbnail display for an image file including a thumbnail has been completed on the screen 607. Since each of the display processing from the screen 602 to the screen 607 is processing to display a thumbnail included in an image file, the time required for the processing is short.

Thereafter, at each of the regions 612, 616, and 618 for each of which a thumbnail has not been displayed, a thumbnail obtained by decompressing a main image is sequentially displayed, and a screen on which all the images of the nine images are displayed is the screen 610. In the case of displaying each of the screen 608, the screen 609, and the screen 610, processing to generate a thumbnail from a main image is required. Therefore, in comparison with the case of displaying each of the screens 602 to 607, the time required for processing such as reduction processing for a main image becomes longer.

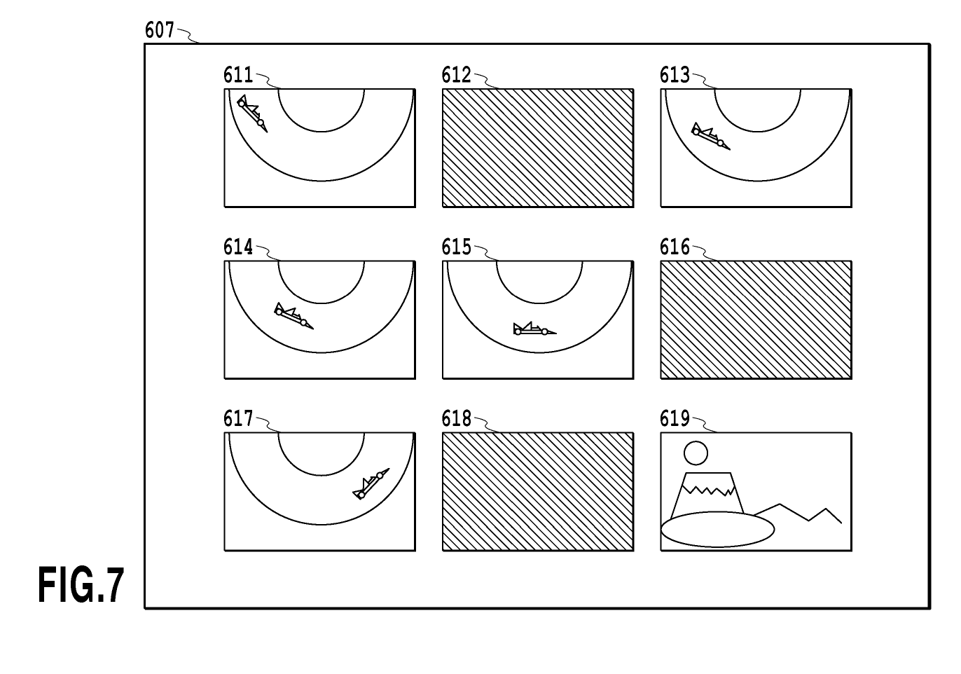

FIG. 7 is an illustration showing the screen 607 in more detail. It is found that many images have already been displayed before performing the processing of each of the regions 612, 616 and 618, which takes time until a thumbnail is displayed. If images are sequentially displayed in accordance with order from 611 to 619 in FIG. 7, for example, before displaying the image of 619, the generation of a thumbnail from a main image for each of three images has to be carried out. In this embodiment, the image of 619 can be displayed by skipping such generation of a thumbnail.

According to the display control processing in this embodiment, for example, a user who has checked the image of 619 in FIG. 7 may be able to determine more quickly whether a desired image is displayed on the current screen or displayed on the subsequent screens. In the example shown in FIG. 7, it is found that among the display images, the image of 619 is different from the scene of other images. Since the order of arranging these nine images is the order of photographing them, even if the images of 612 and 616 are not displayed, it can be predicted that these images are the same as the images of 611, 613, 614, 615, and 617. Furthermore, it can be determined from the image of 617 that the photographic scene has been changed to the image of 618 or 619. Accordingly, for example, in the case where the user is searching the same scene as the image 611 and the like, it can be determined that the desired image is displayed on the current screen. On the other hand, in the case where the user is searching an image of the same photographic scene as the image of 619, it can be determined that the possibility that the image is displayed on the subsequent screens is high.

Therefore, according to the processing of this embodiment, since a user can determine appropriately and quickly whether to change a screen, the user can easily search a desired image.

In the example shown in FIGS. 6 and 7, with the intention of simplifying the description, the example of displaying only a thumbnail is used, but information indicating a file name, the content of a file and the like may be displayed in the vicinity of the thumbnail.

As described above, according to this embodiment, before performing the thumbnail generation processing from a main image, which takes time, there is displayed a thumbnail which is included beforehand in a file and is capable of being displayed. For this reason, many thumbnails can be displayed at a time point when the thumbnail generation processing is started. Therefore, since a user who is looking for a desired image file can check many thumbnails in shorter time, the user can find a desired image file more early. Namely, the number of display images per unit time can be increased, whereby it becomes possible for a user to efficiently perform an image searching operation. Furthermore, a user can determine promptly whether to change the current screen to the next screen, or whether to select an image on the current screen.

### Second Embodiment

In Embodiment 1, description has been given to an example in which thumbnail display is performed in a time-series order, and for image files not including a thumbnail, a thumbnail is generated in a time-series order from the oldest. In Embodiment 2, description will be given to an example in which the order of generating a thumbnail is changed to another order. Also in Embodiment 2, the image processing apparatus with the same configuration as Embodiment 1 is used.

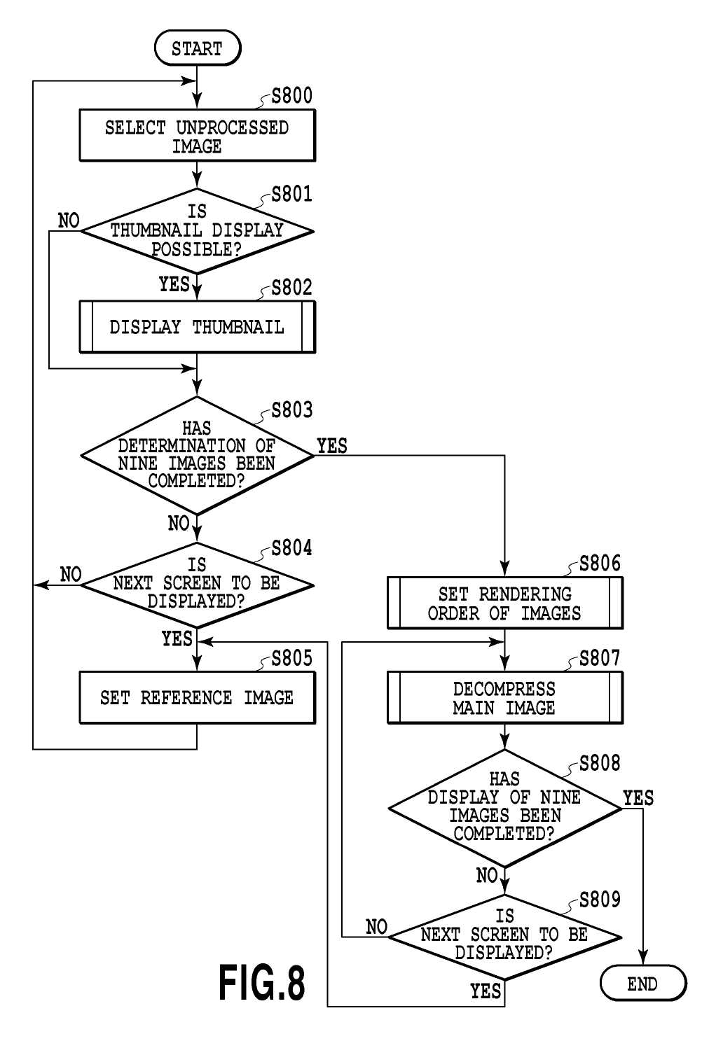

FIG. 8 is a drawing showing an example of processing according to Embodiment 2. Since the steps of Step S800 to Step S805 and Step S807 to Step S808 are, respectively, the same as the steps of Step S500 to Step S505 and Step S507 to S508, descriptions thereof are omitted.

In Step S806, the thumbnail display unit 203 sets up the rendering order of the images, of which thumbnail display is determined to be impossible in Step S801. Namely, the thumbnail display unit 203 sets up the generating order of the images for which the thumbnail generating unit 204 generates a thumbnail. This order may be any kind of orders, but in this embodiment, sorting is performed in the ascending order in accordance with the size of a main image included in an image file not including a thumbnail, and the image rendering order is set up. That is, a thumbnail is generated sequentially in order from an image file in which the size of a main image included in the image file not including a thumbnail is smaller.

In Step S809, the thumbnail display unit 203 determines whether or not input of a request for displaying the next screen from a user via the operation unit 105 is detected. In the case where there is no input, the thumbnail display unit 203 advances the processing to Step S807, and successively repeats thumbnail display by decompression of a main image in accordance with the setting in Step S806. In the case where the input of a request for displaying the next screen has been performed in Step S809, the operation moves to Step S805.

As described above, in this embodiment, since a thumbnail is generated and displayed in order from a thumbnail in which the processing time to generate a thumbnail is shorter, the number of display image sheets per unit time can be enhanced in comparison with that in Example 1.

### Third Embodiment

In Embodiment 1 and Embodiment 2, description has been given to an example of displaying a screen in which all the currently-displayed nine images are made into other images, in the case where a user requests to display the next screen. In this embodiment, description will be given to a configuration in which all the currently-displayed nine images are not made another images and a part of the nine images is displayed also on the next screen, in the case where a user requests to display the next screen. As described in the previous embodiments, in the case where nine images are displayed on a single screen, for example, the nine images with three rows and three columns are arranged. Then, for example, in the case where the next screen is displayed, description will be given to processing to display the screen in which the arrangement of the images is changed in units of a row.

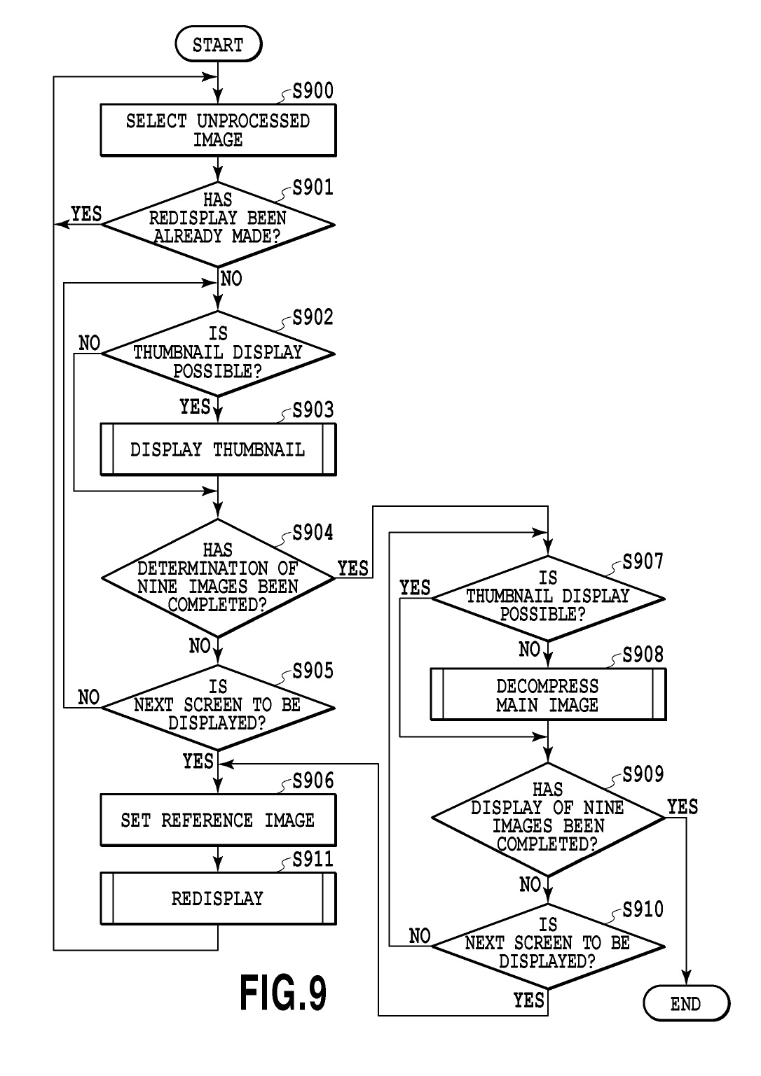

FIG. 9 is a flowchart showing an example of the processing according to Embodiment 3. Since the steps of Step S900 and Step S902 to Step S905, and Step S907 to Step S910 are, respectively, the same as the steps of Step S500 to Step S504 and Step S506 to S509, descriptions thereof are omitted.

In Step S901, the thumbnail display unit 203 determines whether or not the thumbnail redisplay is performed. That is, it is determined whether the image to be processed, selected in Step S900, is a redisplayed thumbnail. The fact that the thumbnail redisplay is performed means the fact that, for example, in the case where a request for displaying the next screen has been made, the redisplay in Step S911 described later is performed. In the case where it is determined that the redisplay is performed, the thumbnail display unit 203 advances again to Step S900, selects the following unprocessed image as the image to be processed, and makes the determination in Step S901. In the case where it is determined that the redisplay is not performed, the thumbnail display unit 203 advances the processing to Step S902.

In Step S906, the thumbnail display unit 203 changes a reference image in order to display the next screen. In this embodiment, a screen where row feed is made is displayed on the next screen. That is, among the nine images, the arrangement of the last six images is changed, and the six images are redisplayed. Furthermore, nine images obtained by newly adding three images are displayed as the next screen. Then, the thumbnail display unit 203 changes the reference image from the image file 319 being the currently-set value to the image file 322, in Step S906. In addition, in Step S911, the thumbnail display unit 203 newly performs the displaying of nine images. In Step S911, the thumbnail display unit 203 redisplays the already-displayed thumbnails in the images in which the arrangement of the images is changed on the screen before and after the change of the reference image. Specifically, the thumbnail display unit 203 performs the redisplay through the use of thumbnails stored temporarily in the image buffer of the RAM. 103. A thumbnail which is newly generated in the case where a thumbnail is not included in the image file, is also temporarily stored in the image buffer of the RAM 103. Subsequently, the thumbnail display unit 203 advances the processing to Step S900, and selects the image to be processed among the nine images which are newly rendered.

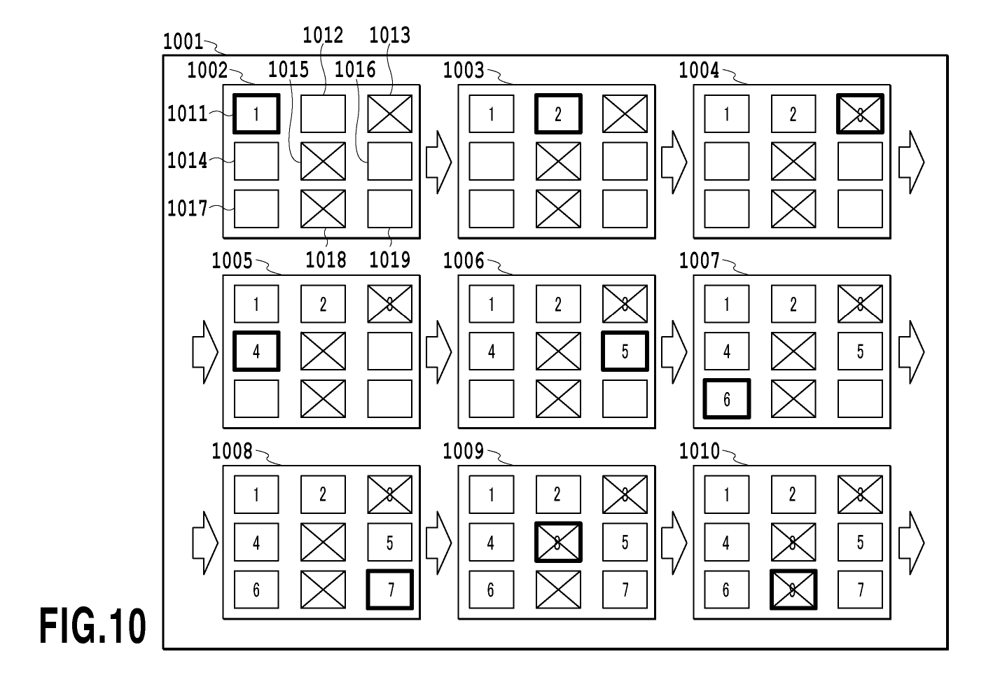

FIG. 10 is an illustration showing an example of displaying in time series in the case where, at the time point of the screen 609 shown in FIG. 6, the thumbnail display unit 203 detects the input of a request for displaying the next screen in Step S910 in FIG. 9, and thereafter, the image files 322 to 330 are displayed as nine image as the next screen. In order from a screen 1002 to a screen 1010, thumbnails are displayed on respective regions. In FIG. 10, first, the thumbnails of the image files 322, 323, 324, 325, and 327 having been already displayed before the change of the reference image are redisplayed on the respective regions 1011, 1012, 1013, 1014, and 1016 by the processing in S911. The screen at the time point when these thumbnails are redisplayed is the screen 1006.

In addition, among the images which have not been displayed before the change of the reference image by the thumbnail display processing in Step S902 and Step S903, the thumbnails of the image files 328 and 330 of which thumbnail display is possible are displayed on the regions 1017 and 1019. The screen at this time is the screen 1008. Finally, the thumbnails of the image files 326 and 329 where a thumbnail is not saved are generated by the thumbnail generating unit 204, and are displayed on the regions 1015 and 1018.

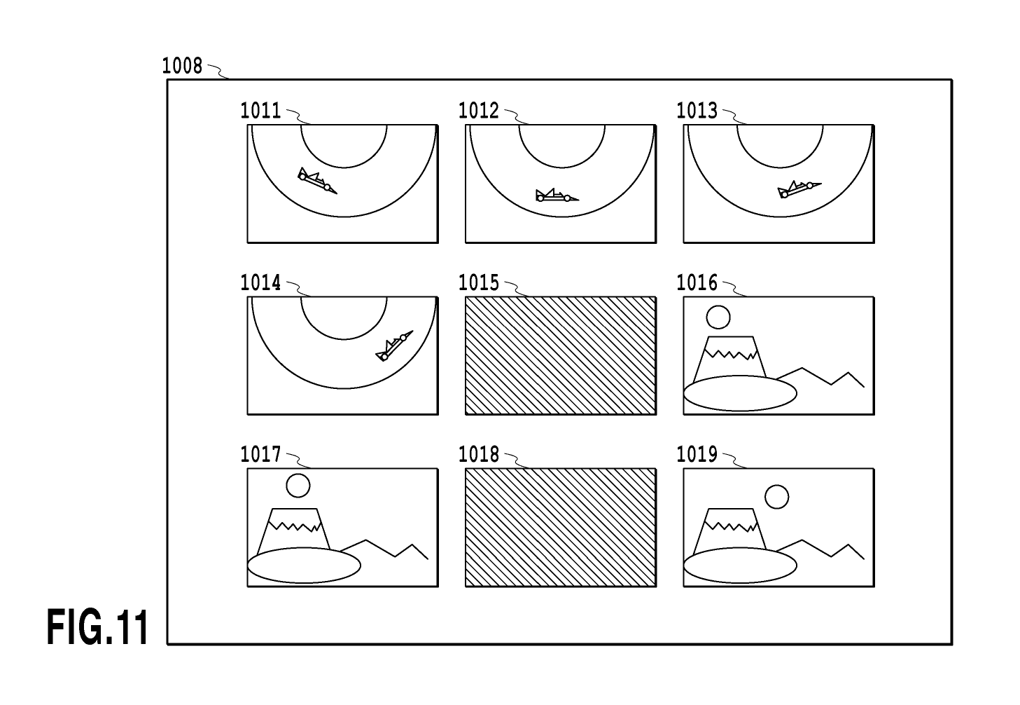

FIG. 11 is an illustration showing the screen 1008 in more detail. It is found that many thumbnails are already displayed before performing the processing of the regions 1015 and 1018, which takes time until a thumbnail is displayed.

As described above, according to this embodiment, in the case where images of which thumbnails have been already displayed are displayed again, the number of display image sheets per unit time can be enhanced since the display can be performed through the use of the generated thumbnails.

### <Others>

In each of the above embodiments, description has been given to the example of displaying thumbnails of image files input from the memory card 108 via the memory card I/F 109. However, the present invention is not limited to the example. For example, the image processing apparatus 101 may obtain image files from apparatuses connected to other networks via a network IF, and may obtain image files from apparatuses USB-connected via a USB interface. Furthermore, the image processing apparatus 101 may perform the processing of each of the above embodiments by obtaining image files stored beforehand in a HDD and the like. In this case, the file list storage unit 202 stores a list of image files in a prescribed folder.

Moreover, the image processing apparatus 101 may be a computer such as a PC, may be an input and output apparatus such as a camera and a printer, and may be a mobile terminal such as a smart phone. For example, in a mode of displaying thumbnails of a file stored in a cloud server by using a smart phone, there is considered a case where it takes time to generate a thumbnail depending on a communication speed. Each of the above embodiments is useful in a mode of cooperating with such a cloud server.

Furthermore, in the above description, there is shown the example of displaying a thumbnail on the display unit included in the image processing apparatus 101. However, the present invention is not limited to the example, and a display control may be performed on an external display device connected to the image processing apparatus 101.

Furthermore, in each of the above embodiments, the description has been given by taking an image file of still images such as JPEG, as an example, and each of the above embodiments may be applied to a thumbnail of a moving image. In the case of a file which is a moving image file and does not include a thumbnail, a thumbnail may be generated by using the image of a preliminarily-set scene as a main image at the time of generating the above thumbnail. As a typical example, a thumbnail may be generated by using an image at the time of start of a moving image as a main image, but a thumbnail of any scene may be generated.

In addition, in each of the above embodiments, the description has been given by taking the image file and the thumbnail as an example. However, the present invention is not limited to the example, and a document file such as PDF (Portable Document Format) and its thumbnail may be used as the image file in each of the above embodiments, and the display control processing of each of the above embodiments may be applied to the image file. In the case of a file which is a document file and does not include a thumbnail, a thumbnail may be generated by using the image of a preliminarily-set page as a main image at the time of generating the above thumbnail. As a typical example, a thumbnail may be generated by using an image on the first page of a document file as a main image, but a thumbnail of any page may be generated.

Furthermore, in each of the above embodiments, the description has been given by taking the image file and the thumbnail as an example, but each of the above embodiments may be applied also to a file of a web page such as HTML (HyperText Markup Language), and its thumbnail. In the case of a file which is a web page and does not include a thumbnail, in generating the above thumbnail, a thumbnail may be generated by using, as a main image, an image at the time of reading a preliminarily-set page via a browser or the like. As a typical example, a thumbnail may be generated by using an image on the first page of a web page as a main image, but a thumbnail of any page may be generated.

Moreover, in each of the above embodiments, the description has been given of the example in which a plurality of thumbnails (for example, nine sheets) is displayed sequentially on the same screen. However, the present invention is not limited to the example, and the display control processing of each of the above embodiments can be applied also to a case where images to be displayed are sequentially displayed while being switched, as in the case of, for example, displaying a slide show.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment (s) and/or that includes one or more circuits (e.g., application specific integrated circuit (ASIC)) for performing the functions of one or more of the above-described embodiment (s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment (s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-262864, filed Dec. 19, 2013, which is hereby incorporated by reference wherein in its entirety.

What is claimed is:

1. An image processing apparatus, comprising
an obtaining unit configured to obtain a thumbnail from a first image file including the thumbnail among a plurality of image files to be processed;
a generating unit configured to generate a thumbnail based on image data included in a second image file which does not include a thumbnail among the plurality of image files to be processed; and
a display control unit configured to sequentially display, on a display device, a plurality of thumbnails corresponding to the plurality of image files to be processed such that a thumbnail obtained by the obtaining unit is displayed in preference to a thumbnail generated by the generating unit.

2. The image processing apparatus according to claim 1, wherein the display control unit, in a case where the plurality of image files include a plurality of the first image files each including a thumbnail, displays a plurality of thumbnails obtained by the obtaining unit from the plurality of the first image files, and thereafter, displays a thumbnail generated by the generating unit based on the second image file.

3. The image processing apparatus according to claim 1, wherein the display control unit displays the plurality of thumbnails on a plurality of regions respectively on a single screen of the display device.

4. The image processing apparatus according to claim 3, wherein the display control unit in a case of being instructed to display a next screen, if the plurality of thumbnails of the displayed target include a thumbnail having been already decompressed in a memory included in the image processing apparatus, displays the decompressed thumbnail, and thereafter, displays the thumbnail generated by the generating unit.

5. The image processing apparatus according to claim 3, wherein the display control unit in a case of being instructed to display a next screen displays a plurality of thumbnails in order of a thumbnail capable of being redisplayed, a thumbnail of an image file including the thumbnail among image files to be newly processed, and a thumbnail generated by the generating unit.

6. The image processing apparatus according to claim 1, wherein the generating unit generates a thumbnail in accordance with a set order.

7. The image processing apparatus according to claim 1, wherein the generating unit generates a thumbnail based on a main image included in the second image file.

8. The image processing apparatus according to claim 7, wherein the generating unit, in a case where the plurality of image files includes a plurality of the second image files, generates a thumbnail in an ascending order from an image file including a main image with a small size.

9. The image processing apparatus according to claim 1, wherein the generating unit decompresses an image based on data included in the second image file, and generates a thumbnail by generating a reduced image of the decompressed image.

10. The image processing apparatus according to claim 1, wherein the second image file includes an image file including a thumbnail different in aspect ratio from an image based on image data included in the second image file.

11. An image processing method, comprising
an obtaining step of obtaining a thumbnail from a first image file including the thumbnail among a plurality of image files to be processed;
a generating step of generating a thumbnail based on image data included in a second image file which does not include a thumbnail among the plurality of image files to be processed; and
a display control step of sequentially display, on a display apparatus, a plurality of thumbnails corresponding to the plurality of image files to be processed such that the thumbnail obtained by the obtaining step is displayed in preference to the thumbnail generated by the generating step.

12. The image processing method according to claim 11, wherein the display control step includes, in a case where the plurality of image files include a plurality of the first image files each including a thumbnail, displaying a plurality of thumbnails obtained in the obtaining step from the plurality of the first image files, and thereafter, displaying a thumbnail generated in the generating step based on the second image file.

13. The image processing method according to claim 11, wherein the display control step includes displaying the plurality of thumbnails on a plurality of regions respectively on a single screen of the display device.

14. The image processing method according to claim 13, wherein the display control step includes in a case of being instructed to display a next screen, if the plurality of thumbnails of the displayed target include a thumbnail having been already decompressed in a memory included in the image processing apparatus, displaying the decompressed thumbnail, and thereafter, displaying the thumbnail generated in the generating step.

15. The image processing method according to claim 13, wherein the display control step includes in a case of being instructed to display a next screen displaying a plurality of thumbnails in order of a thumbnail capable of being redisplayed, a thumbnail of an image file including the thumbnail among image files to be newly processed, and a thumbnail generated in the generating step.

16. The image processing method according to claim 11, wherein the generating step includes generating a thumbnail in accordance with a set order.

17. The image processing method according to claim 11, wherein the generating step includes generating a thumbnail based on a main image included in the second image file.

18. The image processing method according to claim 17, wherein the generating step includes, in a case where the plurality of image files includes a plurality of the second image files, generating a thumbnail in an ascending order from an image file including a main image with a small size.

19. The image processing method according to claim 11, wherein the generating step includes decompressing an image based on data included in the second image file, and generating a thumbnail by generating a reduced image of the decompressed image.

20. A non-transitory computer-readable storage medium storing a program which causes a computer to perform the image processing method according to claim 11.
